(19) United States
(12) Patent Application Publication
(10) Pub. No.: US 2016/0198148 A1
(43) Pub. Date: Jul. 7, 2016

(54) AUTO-STEREOSCOPIC IMAGE APPARATUS

(71) Applicant: Panasonic Intellectual Property Management Co., Ltd., Osaka (JP)

(72) Inventor: Yosuke ASAI, Osaka (JP)

(21) Appl. No.: 15/069,291

(22) Filed: Mar. 14, 2016

Related U.S. Application Data
(63) Continuation of application No. PCT/JP2014/004041, filed on Aug. 1, 2014.

(30) Foreign Application Priority Data
Sep. 27, 2013 (JP) 2013-201517

(51) Int. Cl. H04N 13/04

(52) U.S. Cl. CPC H04N 13/0404; H04N 13/0409; H04N 13/0422; H04N 13/047; H04N 2213/001

(57) ABSTRACT

An auto-stereoscopic image apparatus according to the present disclosure includes a display panel configured to include a plurality of sub pixels and to display images corresponding to a plurality of viewpoints; an optical element configured to be disposed in front of the display panel and to provide parallaxes for the images; a viewpoint detector configured to detect positions of the plurality of viewpoints; and a controller configured to determine viewpoint boundary position of the plurality of sub pixels based on the positions of the plurality of viewpoints and to allocate pixel values of the plurality of sub pixels based on the viewpoint boundary positions.

### BACKGROUND OF THE INVENTION

1. Field of the Invention

The present disclosure relates to an auto-stereoscopic image apparatus that changes a display position of auto-stereoscopic image dependent on a position of a viewpoint.

2. Description of the Related Art

Patent Literature 1 discloses a parallax image information processing method that variably adjusts an optimum viewable distance and a viewing angle. In this processing method, parallax image information including two or more parallaxes is allocated to each vertical pixel of a liquid crystal panel. When a stereoscopic image is viewed through a parallax barrier disposed in front of the liquid crystal panel, each of parallax image information is allocated to each vertical pixel in a predetermined dividing ratio.

### CITATION LIST

### Patent Literature

PTL 1: Unexamined Japanese Patent Publication No. 2012-255922

### SUMMARY OF THE INVENTION

The present disclosure provides an auto-stereoscopic image apparatus that changes a display position of an auto-stereoscopic image dependent on a position of a viewpoint.

An auto-stereoscopic image apparatus according to the present disclosure includes a display panel configured to include a plurality of sub pixels and to display images corresponding to a plurality of viewpoints; an optical element configured to be disposed in front of the display panel and to provide parallaxes for the images; a viewpoint detector configured to detect positions of the plurality of viewpoints; and a controller that determine viewpoint boundary position of the plurality of sub pixels based on the positions of the plurality of viewpoints and to allocate pixel values of the plurality of sub pixels based on the viewpoint boundary positions.

The auto-stereoscopic image apparatus according to the present disclosure can display an auto-stereoscopic image corresponding to a change of a position of a viewpoint.

### BRIEF DESCRIPTION OF DRAWINGS

FIG. 1 is a schematic diagram showing an auto-stereoscopic image apparatus according to a first exemplary embodiment.

FIG. 2 is a schematic diagram showing an enlarged portion of an auto-stereoscopic display unit shown in FIG. 1.

FIG. 3 is a schematic diagram showing an auto-stereoscopic image apparatus according to a second exemplary embodiment.

FIG. 4 is a schematic diagram comparing the auto-stereoscopic display unit according to the first exemplary embodiment with the auto-stereoscopic display unit according to the second exemplary embodiment.

FIG. 5 is a schematic diagram showing an auto-stereoscopic image apparatus according to a third exemplary embodiment.

FIG. 6A is a schematic diagram showing an enlarged portion of the auto-stereoscopic display unit shown in FIG. 5.

FIG. 6B is an enlarged view showing a part surrounded by dotted lines in FIG. 6A.

### DETAILED DESCRIPTION OF THE PREFERRED EMBODIMENTS

Hereinafter, exemplary embodiments will be described in detail with reference to the accompanying drawings as appropriate. However, unnecessarily detailed description may occasionally be omitted. For example, detailed description of well-known matters and redundant description of substantially the same configurations may occasionally be omitted. The omission of these items is to avoid the following description from becoming unnecessarily redundant, and to ease understanding of those skilled in the art.

It should be noted that the following description and the accompanying drawings are provided to allow any person skilled in the art to fully understand the present disclosure, and that it is not intended to limit the subject matter described in the claims by the following description and the accompanying drawings.

### First Exemplary Embodiment

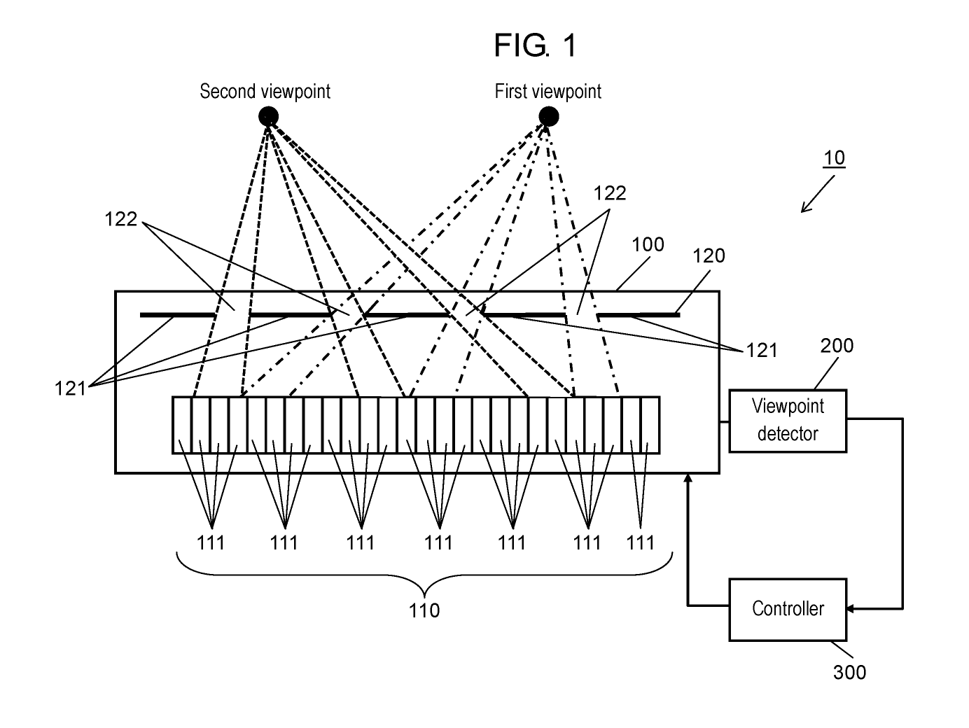

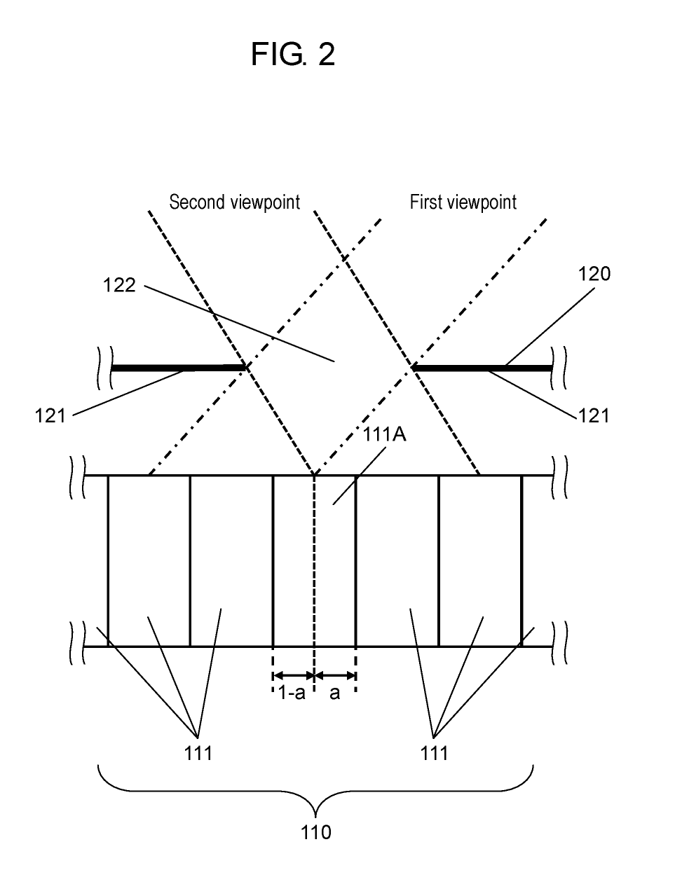

Next, with reference to FIGS. 1 and 2, an auto-stereoscopic image apparatus in two viewpoints according to the first exemplary embodiment will be described.

### [1-1. Structure]

FIG. 1 is a schematic diagram showing an auto-stereoscopic image apparatus in two viewpoints according to the first exemplary embodiment. Auto-stereoscopic image apparatus 10 employs a parallax barrier system that shows different separated images to respective left and right eyes of a user so that the user views a stereoscopic image. Auto-stereoscopic image apparatus 10 includes auto-stereoscopic display unit 100, viewpoint detector 200, and controller 300.

Auto-stereoscopic display unit 100 includes display panel 110 and parallax barrier 120. Display panel 110 includes a plurality of sub pixels 111 that display individual colors of R (red), G (green), and B (blue). Pixel values of sub pixels 111 are determined by controller 300. There are a first viewpoint and a second viewpoint that are positions of the eyes of the user and that are away from display panel 110 by predetermined distances. Sub pixels 111 are arranged periodically, alternately images for the first viewpoint and images for the second viewpoint in a horizontal direction. As long as display panel 110 includes a plurality of sub pixels, display panel 110 may be a liquid crystal panel, a plasma panel, an organic Electro-Luminescence (EL) panel, a Cathode Ray Tube (CRT), or the like. Parallax barrier 120 is a plate-like light shielding member that separately displays images for the first viewpoint and images for the second viewpoint displayed on display panel 110. Parallax barrier 120 is an optical element including light shielding portions 121 and open portions 122. The optical element is alternately, periodically disposed light shielding portions 121 and open portions 122. A ratio of a width of light shielding portion 121 and a width of open portion 122 of parallax barrier 120 may be or may not be 1 to 1. A period for placement of light shielding portions 121 and open portions 122 of parallax barrier 120 may be or may not be an integer multiple of a period of sub pixels 111 of display panel 110.

Viewpoint detector 200 detects the first viewpoint and the second viewpoint. To change a stereoscopic view range in a three-dimensional space, viewpoint detector 200 requires position information of the eyes of the user. The position information are a distance from auto-stereoscopic display unit 100 to the eyes of the user, horizontal positions of the eyes of the user to auto-stereoscopic display unit 100, and vertical positions of the eyes of the user to auto-stereoscopic display unit 100.

Controller 300 allocates an image for the first viewpoint and an image for the second viewpoint for each sub pixel 111 in accordance with the positions of the first viewpoint and the second viewpoint detected by viewpoint detector 200. First, controller 300 determines the periods of the image for the first viewpoint and the image for the second viewpoint periodically, alternately arranged in the horizontal direction based on the distances from auto-stereoscopic display unit 100 to the first viewpoint and the second viewpoint. Next, controller 300 determines to allocate images for the first viewpoint and images for the second viewpoint to the plurality of sub pixels 111 of display panel 110 based on the information detected by viewpoint detector 200 about the horizontal positions of the eyes of the user to auto-stereoscopic display unit 100 and the vertical positions of the eyes of the user to auto-stereoscopic display unit 100.

FIG. 2 is a schematic diagram showing an enlarged portion of auto-stereoscopic display unit 100 shown in FIG. 1. As shown in FIG. 2, when images for the first viewpoint image and images for the second viewpoint are allocated to the plurality of sub pixels 111 of display panel 110, some of sub pixels 111 may not be allocated only an image for the first viewpoint or only an image for the second viewpoint. In this case, sub pixel 111A that includes both the image for the first viewpoint and the image for the second viewpoint exists. A pixel value of sub pixel 111A is a value in which the image for the first viewpoint and the image for the second viewpoint are mixed in a predetermined dividing ratio. Controller 300 determines a position at which the image for the first viewpoint changes to the image for the second viewpoint on display panel 110, namely a viewpoint boundary position. As shown in FIG. 2, in sub pixel 111A including the viewpoint boundary position, a ratio of a width of the image for the second viewpoint is expressed by “a” (where “a” is a real number in a range of “0<a<1”). If a pixel value of the image for the first viewpoint of sub pixel 111A is expressed by “X” and a pixel value of the image for the second viewpoint of sub pixel 111A is expressed by “Y,” then a pixel value of sub pixel 111A is expressed by “X×(1−a)+Y×a.”

### [1-2. Effect, etc.]

As described above, in auto-stereoscopic image apparatus 10 according to the present exemplary embodiment, viewpoint detector 200 detects the positions of the eyes of the user. Controller 300 allocates pixel values to sub pixels based on the detected positions of the eyes of the user. Auto-stereoscopic display unit 100 displays images.

Thus, auto-stereoscopic display unit 100 can allocate pixel values to sub pixels so that the user can optimally view images. As a result, the user can view auto-stereoscopic images without worrying about a viewing position.

In addition, since the pixel value of a sub pixel in which an image for the first viewpoint and an image for the second viewpoint are mixed is expressed by “X×(1−a)+Y×a” (where “a” is a real number in a range of “0<a<1”), a sub pixel that is at the boundary of the image for the first viewpoint and the image for the second viewpoint can optimally display the mixed image. As a result, high-quality auto-stereoscopic images can be provided.

### Second Exemplary Embodiment

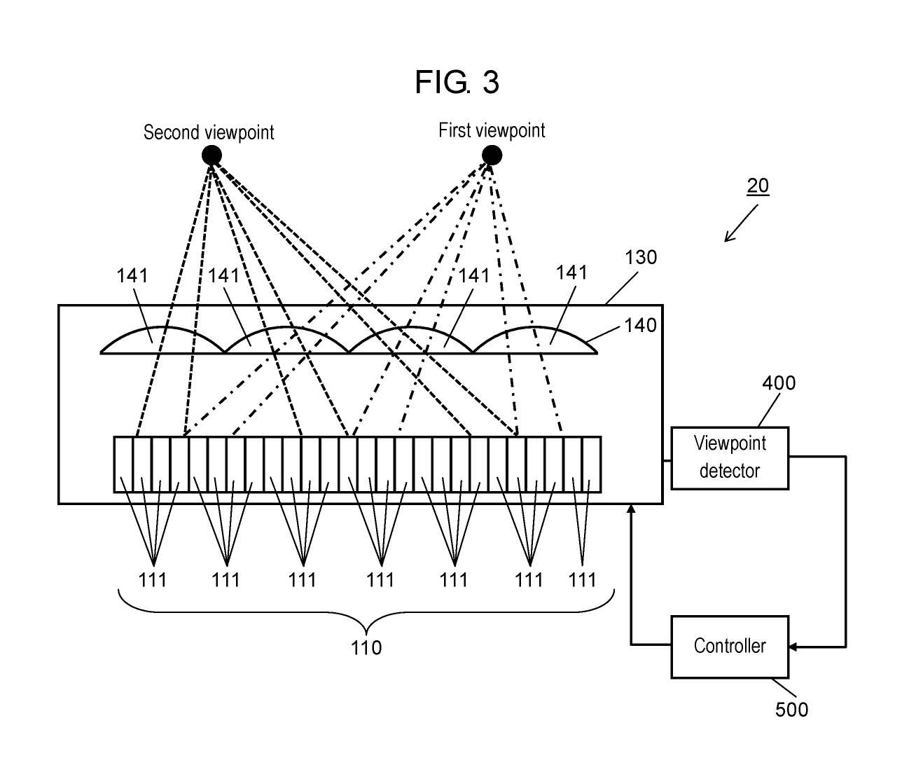

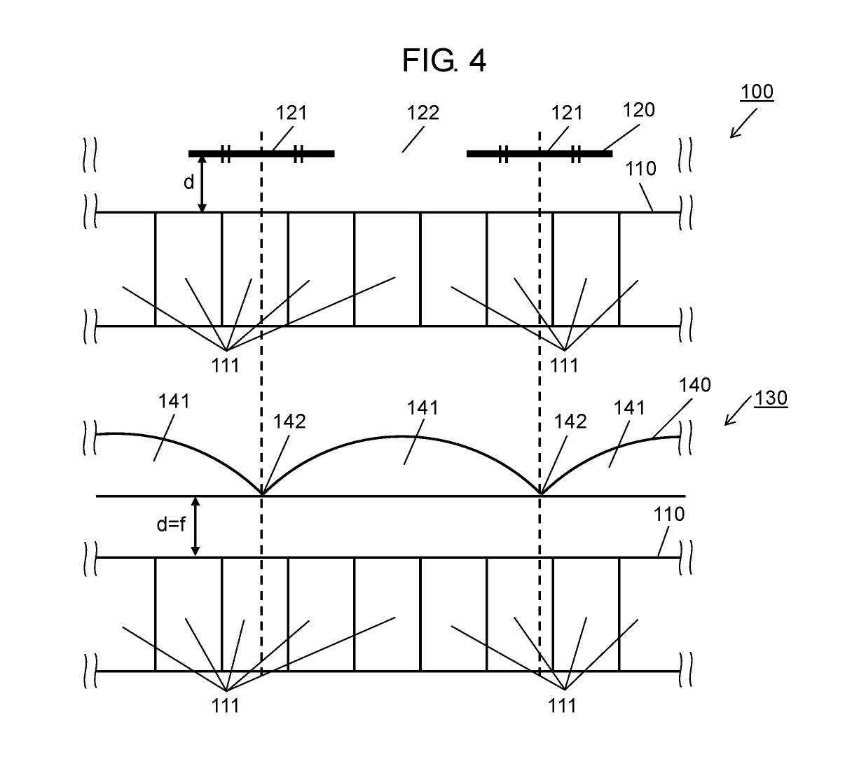

Next, with reference to FIGS. 3 and 4, the second exemplary embodiment will be described.

### [2-1. Structure]

FIG. 3 is a schematic diagram showing auto-stereoscopic image apparatus 20 in two viewpoints according to the second exemplary embodiment. Auto-stereoscopic image apparatus 20 employs a lenticular system that uses a sheet-type lenticular lens to display stereoscopic images.

The present exemplary embodiment has a structure in which parallax barrier 120 used in the first exemplary embodiment is substituted with lenticular lens 140. Auto-stereoscopic image apparatus 20 includes auto-stereoscopic display unit 130, viewpoint detector 400, and controller 500.

Auto-stereoscopic display unit 130 includes display panel 110 and lenticular lens 140. Display panel 110 includes a plurality of sub pixels 111 that display individual colors of R (red), G (green), and B (blue). Pixel values of sub pixels 111 are determined by controller 500. There are a first viewpoint and a second viewpoint that are positions of the eyes of the user and that are away from display panel 110 by predetermined distances. Sub pixels 111 are arranged periodically, alternately images for the irst viewpoint and images for second viewpoint in a horizontal direction. Lenticular lens 140 includes a plurality of hog-backed convex lenses 141.

FIG. 4 is a schematic diagram comparing auto-stereoscopic display unit 100 according to the first exemplary embodiment with auto-stereoscopic display unit 130 according to the second exemplary embodiment.

Lenticular lens 140 of auto-stereoscopic display unit 130 has a structure in which a midpoint of light shielding portion 121 of parallax barrier 120 of auto-stereoscopic display unit 100 corresponds to lens end 142 that is a trough between adjacent convex lenses 141. In addition, lenticular lens 140 and display panel 110 are disposed so that a distance there between is equal to a distance d between parallax barrier 120 and display panel 110. Specifically, the distance d is a focal distance f of lenticular lens 140.

Viewpoint detector 400 detects the first viewpoint and the second viewpoint. To change a stereoscopic view range in a three-dimensional space, viewpoint detector 400 requires position information of the eyes of the user. The position information are a distance from auto-stereoscopic display unit 130 to the eyes of the user, horizontal positions of the eyes of the user to auto-stereoscopic display unit 100, and vertical positions of the eyes of the user to auto-stereoscopic display unit 130.

Controller 500 allocates an image for the first viewpoint and an image for the second viewpoint for each sub pixel 111 in accordance with the positions of the first viewpoint and the second viewpoint detected by viewpoint detector 400. First, controller 500 determines the periods of the image for the first viewpoint and image for the second viewpoint periodically, alternately arranged in the horizontal direction based on the distances from auto-stereoscopic display unit 130 to the first viewpoint and the second viewpoint. Next, controller 500 determines to allocate images for the first viewpoint and images for the second viewpoint to the plurality of sub pixels 111 of display panel 110 based on the information detected by viewpoint detector 400 about the horizontal positions of the eyes of the user to auto-stereoscopic display unit 130 and the vertical positions of the eyes of the user to auto-stereoscopic display unit 130.

As in the first exemplary embodiment, when images for the first viewpoint and images for the second viewpoint are allocated to the plurality of sub pixels 111 of display panel 110, some of sub pixels 111 may not be allocated only an image for the first viewpoint or only an image for the second viewpoint. In this case, sub pixel 111A that includes both the image for the first viewpoint and the image for the second viewpoint exists. A pixel value of sub pixel 111A is a value in which the image for the first viewpoint and the image for the second viewpoint are mixed in a predetermined dividing ratio. Controller 500 determines a position at which the image for the first viewpoint changes to the image for the second viewpoint on display panel 110, namely a viewpoint boundary position. In sub pixel 111A including the viewpoint boundary position, a ratio of a width of the image the second viewpoint image is expressed by “a” (where “a” is a real number in a range of “0<a<1”). If a pixel value of the image for the first viewpoint of sub pixel 111A is expressed by “X” and a pixel value of the image for the second viewpoint image of sub pixel 111A is expressed by “Y,” then a pixel value of sub pixel 111A is represented by “X×(1−a)+Y×a.”

The present exemplary embodiment describes the structure using the lenticular lens. Alternatively, as long as light is deflected from display panel 110, any structure that does not use the lenticular lens may be used. For example, a structure using a liquid crystal lens may be used.

### [2-3. Effect, etc.]

As described above, in auto-stereoscopic image apparatus 20 according to the present exemplary embodiment, viewpoint detector 400 detects the positions of the eyes of the user. Controller 500 allocates pixel values to sub pixels based on the detected positions of the eyes of the user. Auto-stereoscopic display unit 130 displays images.

Thus, auto-stereoscopic display unit 130 can allocate pixel values to sub pixels so that the user can optimally view images. As a result, the user can view auto-stereoscopic images without worrying about a viewing position.

In addition, since the pixel value of a sub pixel in which an image for the first viewpoint and an image for the second viewpoint are mixed is expressed by “X×(1−a)+Y×a” (where “a” is a real number in a range of “0<a<1”), a sub pixel that is at the boundary of the image for the first viewpoint and the image for the second viewpoint can optimally display the mixed image. As a result, high-quality auto-stereoscopic images can be provided.

### Third Exemplary Embodiment

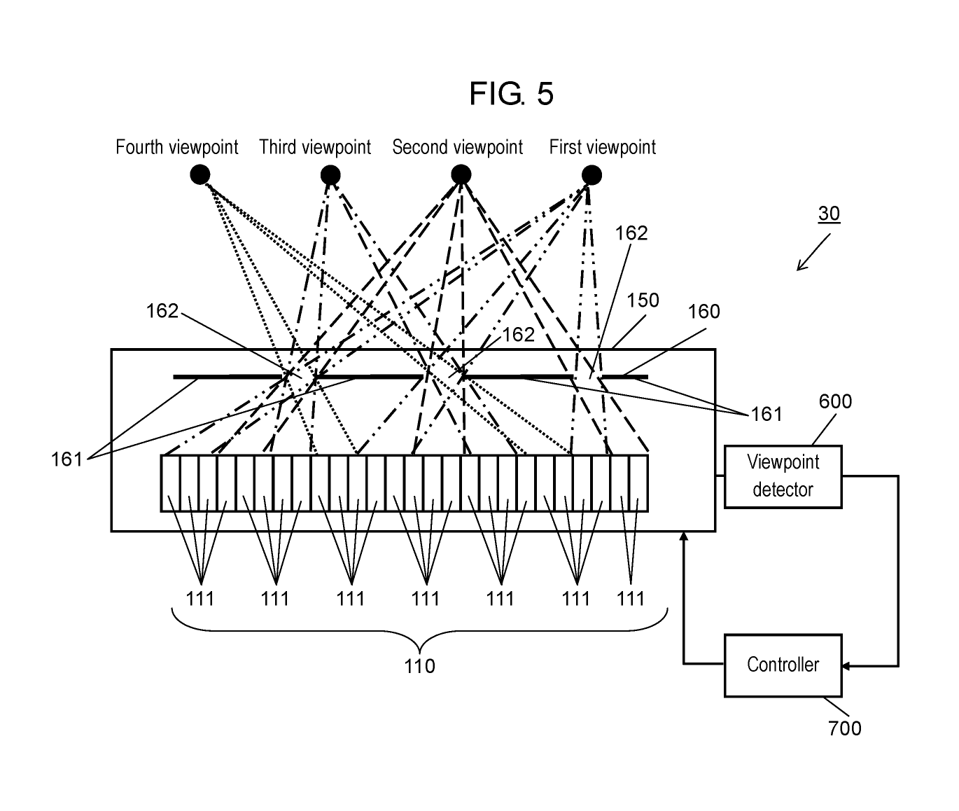

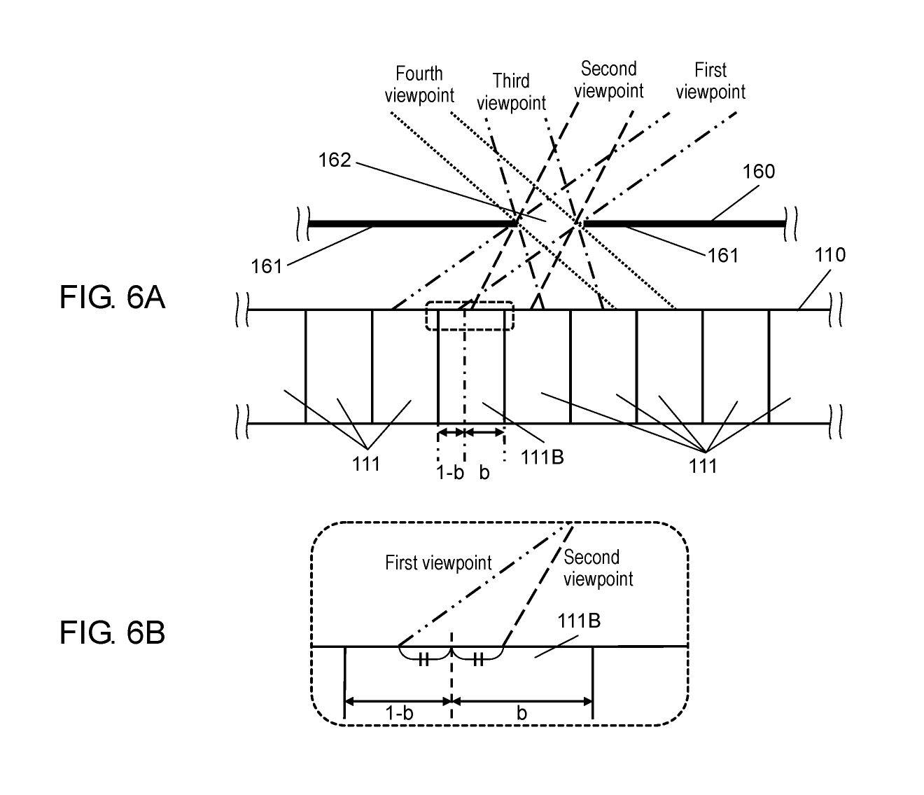

Next, with reference to FIG. 5, FIG. 6A, and FIG. 6B, the third exemplary embodiment will be described.

### [3-1. Structure]

FIG. 5 is an schematic diagram showing auto-stereoscopic image apparatus 30 in four viewpoints according to the third exemplary embodiment. The present exemplary embodiment has a structure in which parallax barrier 120 used in the first exemplary embodiment is substituted with parallax barrier 160.

Auto-stereoscopic image apparatus 30 includes auto-stereoscopic display unit 150, viewpoint detector 600, and controller 700.

Auto-stereoscopic display unit 150 includes display panel 110 and parallax barrier 160. Display panel 110 includes a plurality of sub pixels 111 that display individual colors of R (red), G (green), and B (blue). Pixel values of sub pixels 111 are determined by controller 700. There are a first viewpoint, a second viewpoint, a third viewpoint, and a fourth viewpoint that are positions of the eyes of users and that are away from display panel 110 by predetermined distances. Sub pixels 111 are arranged periodically, alternately images for the first viewpoint image, images for the second viewpoint, images for the third viewpoint, and images for the fourth viewpoint in a horizontal direction. As long as display panel 110 includes a plurality of sub pixels, display panel 110 may be a liquid crystal panel, a plasma panel, an organic EL panel, a CRT, or the like. Parallax barrier 160 is a plate-like light shielding member that separately displays images for the first viewpoint, images for the second viewpoint, images for the third viewpoints and images for the fourth viewpoints displayed on display panel 110. Parallax barrier 160 is an optical element including light shielding portions 161 and open portions 162. The optical element is alternately, periodically disposed light shielding portions 161 and open portions 162. Opening portions 162 of parallax barrier 160 according to the present exemplary embodiment are narrower than those of parallax barrier 120 according to the first exemplary embodiment. Specifically, in parallax barrier 160, a ratio of light shielding portion 161 and open portion 162 is less than 3:1.

Viewpoint detector 600 detects the first viewpoint, the second viewpoint, the third viewpoint, and the fourth viewpoint. To change a stereoscopic view range in a three-dimensional space, viewpoint detector 600 requires position information of the eyes of the users. The position information are a distance from auto-stereoscopic display unit 150 to the eyes of the users, horizontal positions of the eyes of the users to auto-stereoscopic display unit 150, and vertical positions of the eyes of the users to auto-stereoscopic display unit 150.

Controller 700 allocates an image for the first viewpoint, an image for the second viewpoint, an image for the third viewpoint, and an image for the fourth viewpoint for each sub pixel 111 in accordance with the positions of the first viewpoint, the second viewpoint, the third viewpoint, and the fourth viewpoint detected by viewpoint detector 600. First, controller 700 determines the periods of the image for the first viewpoint, the image for the second viewpoint, the image for the third viewpoint, and the image for the fourth viewpoint periodically, alternately arranged in the horizontal direction based on the distances from auto-stereoscopic display unit 150 to the first viewpoint, the second viewpoint, the third viewpoint, and the fourth viewpoint. Next, controller 700 determines to allocate images for the first viewpoint, images for the second viewpoint, images for the third viewpoint, and images for the fourth viewpoint to the plurality of sub pixels 111 of display panel 110 based on the information detected by viewpoint detector 600 about the horizontal positions of the eyes of the users to auto-stereoscopic display unit 150 and the vertical positions of the eyes of the users to auto-stereoscopic display unit 150.

FIG. 6A is schematic diagram showing an enlarged portion of auto-stereoscopic display unit 150 shown in FIG. 5. FIG. 6B is a enlarged view showing a part surrounded by dotted lines in FIG. 6A.

As in the image for the first viewpoint and an image for the second viewpoint, a pixel value of sub pixel 111 is a value in which images for the adjacent viewpoints are mixed in a predetermined dividing ratio. However, as shown in FIG. 6A and FIG. 6B, at sub pixel 111B in which the image for the first viewpoint and the image for the second viewpoint are mixed, the boundary of the first viewpoint and the boundary of the second viewpoint are not in contact with each other. In this case, controller 700 determines that a viewpoint boundary position is equidistant from the boundary of the first viewpoint and the boundary of the second viewpoint. As shown in FIG. 6A and FIG. 6B, in sub pixel 111B including the viewpoint boundary position, the ratio of the width of the image for the second viewpoint is expressed by “b” (where “b” is a real number in a range of “0<b<1”). If a pixel value of the image for the first viewpoint of sub pixel 111B is expressed by “X” and a pixel value of the image for the second viewpoint of sub pixel 111B is expressed by “Y,” then the pixel value of sub pixel 111B is expressed by “X×(1−b)+Y×b.”

In FIG. 6A and FIG. 6B, a pixel value of a sub pixel at the boundary of the first viewpoint and the second viewpoint is obtained. However, the present disclosure is not limited to the above example, likewise, a pixel value of a sub pixel at a boundary of the second viewpoint and the third viewpoint and a pixel value of a sub pixel at a boundary of the third viewpoint and the fourth viewpoint can be obtained.

### [3-3. Effect, etc.]

As described above, in auto-stereoscopic image apparatus 30 according to the present exemplary embodiment, viewpoint detector 600 detects the positions of the eyes of the users. Controller 700 allocates pixel values to sub pixels based on the detected positions of the eyes of the users. Auto-stereoscopic display unit 150 displays images.

Thus, auto-stereoscopic display unit 150 can allocate pixel values to sub pixels so that the user can optimally view images. As a result, the user can view auto-stereoscopic images without worrying about a viewing position.

In addition, since the pixel value of a sub pixel in which an image for the first viewpoint and an image for the second viewpoint are mixed is expressed by “X×(1−b)+Y×b” (where “b” is a real number in a range of “0<b<1”), a sub pixel that is at the boundary of the image for the first viewpoint and the image for the second viewpoint can optimally display the mixed image. As a result, high-quality auto-stereoscopic images can be provided.

What is claimed is:

1. An auto-stereoscopic image apparatus comprising:
a display panel configured to include a plurality of sub pixels and to display images corresponding to a plurality of viewpoints;
an optical element configured to be disposed in front of the display panel and to provide parallaxes for the images;
a viewpoint detector configured to detect positions of the plurality of viewpoints; and
a controller configured to determine a viewpoint boundary position of the plurality of sub pixels based on the positions of the plurality of viewpoints, and to allocate pixel values of the plurality of sub pixels based on the viewpoint boundary positions.

2. The auto-stereoscopic image apparatus according to claim 1,
wherein two adjacent viewpoints among the plurality of viewpoints are designated as a first viewpoint and a second viewpoint, and
if a boundary of the first viewpoint and a boundary of the second viewpoint are not in contact with each other, the controller determines that the viewpoint boundary position is a position that is equidistant from both the boundary of the first viewpoint and the boundary of the second viewpoint.

3. The auto-stereoscopic image apparatus according to claim 1,
wherein two adjacent viewpoints among the plurality of viewpoints are designated as a first viewpoint and a second viewpoint, a pixel value of one of the plurality of sub pixels at the viewpoint boundary position is expressed by “X×(1−a)+Y×a”, where “X” is a pixel value for the first viewpoint, “Y” is a pixel value for the second viewpoint, and “a” is a ratio of the images of the second viewpoint and is a real number in a range of “0<a<1.”

4. The auto-stereoscopic image apparatus according to claim 1,
wherein the optical element is a parallax barrier.

5. The auto-stereoscopic image apparatus according to claim 1,
wherein the optical element is a lenticular lens.

6. The auto-stereoscopic image apparatus according to claim 1,
wherein the optical element is a liquid crystal lens.
